(19) United States
(12) Patent Application Publication
(10) Pub. No.: US 2007/0248189 A1
(43) Pub. Date: Oct. 25, 2007

(54) SYMBOL TIMING DETECTOR AND WIRELESS TERMINAL

(76) Inventors: Maiko Ishikawa, Tokyo (JP); Takehiko Kobayashi, Tokyo (JP); Tatsuya Abe, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/735,678

(22) Filed: Apr. 16, 2007

(30) Foreign Application Priority Data
Apr. 19, 2006 (JP) 2006-116206
Sep. 26, 2006 (JP) 2006-259869

(51) Int. Cl. H04L 27/22; H04L 7/00

(52) U.S. Cl. 375/332; 375/355

(57) ABSTRACT

A wireless terminal detects the symbol timing in a received modulated signal and demodulates the signal. Symbol timing can be stably controlled, even when frequency deviation occurs in the wireless communication frequencies. Sampling means samples signal values of the modulated signals at a period that is shorter than the symbol period. An extraction means extracts, from a plurality of sampling points, what are taken to be signal values at symbol timing points, and sampling point demodulation means performs demodulation with respect to signal values at each sampling point. A value detection means is used to detect the power value at each sampling point resulting from the demodulation. Symbol timing control means are used to control the timing taken to be symbol timing by the extraction means, based on the power values at the sampling points.

### BACKGROUND OF THE INVENTION

1. Field of the Invention

This invention relates to a wireless apparatus, particularly to a wireless apparatus that synchronizes symbol timing. Specifically, in the case of the demodulation of digital modulated signals, the present invention relates to a method of detecting symbol timing to establish symbol synchronization, particularly when the modulation scheme is π/4-shift QPSK (Quadrature Phase Shift Keying).

2. Description of the Prior Art

The receiver of a digital modulation system needs to carry out symbol timing synchronization in order to demodulate received signals and accurately acquire the signal information. Unless the symbol timing on the transmitter side and the symbol timing on the receiver side are synchronized, the information demodulated by the receiver will include errors.

To synchronize the symbol timing, in the case of a π/4-shift QPSK system, for example, methods of detecting the symbol timing include using differential detection of the received baseband signal and zero crossing timing detection of the baseband quadrature component (Q component) and in-phase component (I component), and methods of detecting the symbol timing by applying same. Japanese laid-open patent application 2003-234791 (Reference 1) describes an example of such a system.

As one example, in the wireless apparatus of a mobile communication system, signal demodulation and accurate acquisition of signal information by the digital demodulation system of the receiver is based on the assumption that symbol synchronization has been established. As stated above, if there is no symbol synchronization between transmitter and receiver, the signal information demodulated on the receiver side will contain errors. The zero crossing method is used in the case of π/4-shift QPSK modulation. Specifically, the received signal converted into a digital signal is orthogonally converted into two components, which are an in-phase I component and an quadrature Q component, and symbol timing detected from the zero crossing point. Reference 1 describes an example of such a wireless communication system.

However, a problem with the above conventional technology is that it is inherently susceptible to receiver frequency deviation. Pronounced deviation of the received frequency signal makes it impossible to ascertain the symbol timing point, making it difficult to obtain timing synchronization. Another problem is that when the phase amplitudes of the I and Q components are used for timing synchronization, because it is necessary to be able to accurately acquire the zero crossing timing of the I component, timing synchronization can be rendered impossible if phasing or other such factor makes it impossible to acquire the zero crossing timing of the I component.

Take, for example, the method used to detect symbol timing included in the demodulation processing of a receiver of a mobile station. Since the conventional technology uses the detection of the zero crossing point in the amplitudes of the I or Q component, frequency deviation can cause the phase point after differential detection to undergo a transition on the I or Q axis, making it impossible to correctly detect the zero crossing timing.

As another example, frequency deviation between the transmitter and receiver produces a discrepancy with respect to the phase point obtained by differentially detecting of the received signal. In the case of the detection of the zero crossing point of the I component, for example, frequency deviation that causes the phase point to rotate and oscillate on the Q axis will prevent detection of the zero crossing point, thereby preventing detection of the symbol point timing.

The object of the present invention is to provide a symbol timing detector and wireless terminal that are able to stably detect symbol timing and synchronize the timing, even when frequency deviation occurs in the wireless communication frequencies being used.

### SUMMARY OF THE INVENTION

To attain the above object, the present invention provides a symbol timing detector that detects the symbol timing of a modulated signal, the detector comprising: sampling means for sampling a signal value of the modulated signal modulated at a period that is shorter than a symbol period; sampling point demodulation means that carries out demodulation in respect of signal values at sampling points sampled by the sampling means; value detection means that detects power values or amplitude values resulting from demodulation at sampling points obtained by the sampling point demodulation means; and symbol timing detection means that detects a timing taken to be symbol timing based on values at sampling points detected by the value detection means.

That is, by detecting symbol timing based on the power (or amplitude) values resulting from the demodulation at each sampling point, symbol timing can be stably detected and the timing synchronized, even if, for example, frequency deviation arises in the wireless communication frequencies being used.

Various modulation methods may be used, such as π/4-shift QPSK modulation. Similarly, various corresponding demodulation methods may be used, such as differential detection in the case of π/4-shift QPSK. The signal used may be a complex signal comprised of I and Q components. For the sampling period used for the sampling of the modulation signals, various periods may be used. For example, over-sampling may be employed that uses a period that is N times the symbol period.

Various modes may be used for the detection of the symbol timing based on the power (or amplitude) values at each sampling point. For example, a mode may be used in which the symbol timing is detected based on the amplitude of the power (or amplitude) value at each sampling point, using a signal portion where the power (or amplitude) value is highest at symbol timings and lowest at the midpoint of two adjacent symbol timings.

In an example of the configuration of a symbol timing detector according to the invention, an offset removal means performs a shift whereby, with respect to the power or amplitude values at a plurality (for example, N) of sampling points detected by the value detection means, the minimum value of one symbol period becomes zero (or close to zero). An averaging means averages the power or amplitude values at the sampling points shifted by the offset removal means. Based on the results of the averaging by the averaging means, the symbol timing detection means detects a timing that is taken to be the symbol timing.

Therefore, after removing the offset with respect to the power (or amplitude) values at each sampling point, averaging is carried out on a sampling point by sampling point basis and the results used as a basis to detect the symbol timing. Thus, when averaging is performed to reduce noise, for example, the offset can be removed, improving the precision of the symbol timing detection.

For the offset removal mode, various modes may be used. For example, a mode may be used in which, with respect to the power (or amplitude) values at a plurality (for example, N) of sampling points, the minimum value within one symbol period is detected as an offset value and subtracted from the power (or amplitude) value. Similarly, various modes may be used for the averaging, such as integration.

The present invention also provides a wireless terminal that detects symbol timing of received modulated signals and demodulates the signals, the terminal comprising: sampling means that samples signal values of the modulated signals at a period that is shorter than a symbol period; extraction means that extracts from among signal values at a plurality of sampling points sampled by the sampling means, signal values that are taken to be at symbol timing points; demodulation means that performs demodulation in respect of the extracted signal values; sampling point demodulation means that performs demodulation in respect of signal values at each of the sampling points sampled by the sampling means; value detection means that detects power or amplitude values resulting from demodulation at the sampling points obtained by the sampling point demodulation means; and symbol timing control means that controls the timing of what is taken to be symbol timing by the extraction means, based on the power or amplitude values at each of the sampling points detected by the value detection means.

Therefore, by controlling symbol timing based on the power (or amplitude) values resulting from the demodulation at each sampling point, symbol timing can be stably controlled and the timing synchronized, even if, for example, frequency deviation arises in the wireless communication frequencies being used.

The wireless terminal may further comprise offset removal means that performs a shift whereby, with respect to the power or amplitude values at a plurality of sampling points detected by the value detection means, the minimum value of one symbol period becomes zero or close to zero; an averaging means that averages the power or amplitude values at the sampling points shifted by the offset removal means; wherein the symbol timing control means controls the timing of what is taken to be symbol timing by the extraction means, based on the results of the averaging by the averaging means.

Therefore, after removing the offset with respect to the power (or amplitude) values at each sampling point, averaging is carried out on a sampling point by sampling point basis and the results used as a basis to control the symbol timing. Thus, when averaging is performed to reduce noise, for example, the offset can be removed, improving the precision of the symbol timing control.

The wireless terminal may also be configured with a sampling control means that controls the timing of the sampling carried out by the sampling means, thereby improving the precision of the symbol timing.

Various modes may be used for controlling the timing of the sampling. For example, a mode may be used in which the timing of the sampling is adjusted so that the minimum value of one symbol period detected by the value detection means (or that is the result of averaging by the averaging means) is decreased (to the minimum, for example), or so that the maximum value of one symbol period detected by the value detection means (or that is the result of averaging by the averaging means) is increased (to the maximum, for example).

As described in the foregoing, since in accordance with this invention received (demodulated) signals are sampled using a period that is shorter than the symbol period and the symbol timing is detected based on the power (or amplitude) values resulting from the demodulation at each of the sampling points, symbol timing can be stably detected even if, for example, frequency deviation arises in the wireless communication frequencies being used.

Also in accordance with this invention, after removing the offset with respect to the power (or amplitude) values at each sampling point, averaging is carried out on a sampling point by sampling point basis and the results used as a basis to detect the symbol timing. Therefore, when averaging is performed to reduce noise, for example, the offset can be removed, improving the precision of the symbol timing detection. The invention can also improve the precision of symbol timing detection by controlling the timing of the sampling.

### BRIEF EXPLANATION OF THE DRAWINGS

FIG. 1 is a schematic diagram of the demodulation section in a wireless apparatus according to a first embodiment of the invention.

FIG. 2 is a schematic diagram of the demodulation section in a wireless apparatus according to a second embodiment of the invention.

FIG. 3 shows an example of the processing carried out by the offset removal section.

### DESCRIPTION OF THE PREFERRED EMBODIMENTS

Embodiments of the present invention will now be explicitly explained with reference to the drawings. A configuration for detecting symbol timing by means of a symbol timing detector provided in the demodulation section of the wireless apparatus of a wireless terminal, and a configuration that uses the detection result to control the process timing of the demodulation section. The wireless apparatus is comprised, for example, of a transmitter and a receiver, with the receiver being equipped with a demodulation section. Various types of wireless terminal may be used. For example, it may be one that is carried by a person, such as a portable telephone terminal, or one that is installed at a desired location.

The digital modulation system used in the example of the embodiments is the π/4-shift QPSK modulation system. In the π/4-shift QPSK based modulation used in the embodiments, the phase point is set by adding one of the angles of 45 degrees, 135 degrees, −45 degrees, and −135 degrees, following the QPSK symbol map, to the phase point of the preceding symbol. In the demodulation process, the difference between the angle of the phase point of the current symbol and the angle of the phase point of the preceding symbol is detected, and the detected angle difference used to define the corresponding QPSK symbol point information (data).

The communication signal consists of a preamble and data. As one example, the preamble is made up of QPSK symbol points obtained by the π/4-shift QPSK demodulation process comprising repeated alternations of “01” (+135 degrees) and “10” (−45 degrees). In this case, ideally the midpoint of the two consecutive symbol points “01” and “10” obtained by the demodulation passes through the origin on the IQ plane (zero crossing), and this timing can be used as a basis for detecting (inferring) the symbol point timing. With respect also to the data portion, ideally, since the signal obtained by the demodulation always has a zero crossing point, this timing can be detected and used as a basis for detecting (inferring) the symbol point timing. The timing between adjacent symbols (symbol period) is, for example, set beforehand in the transmitter and receiver.

A first embodiment of the invention will now be described.

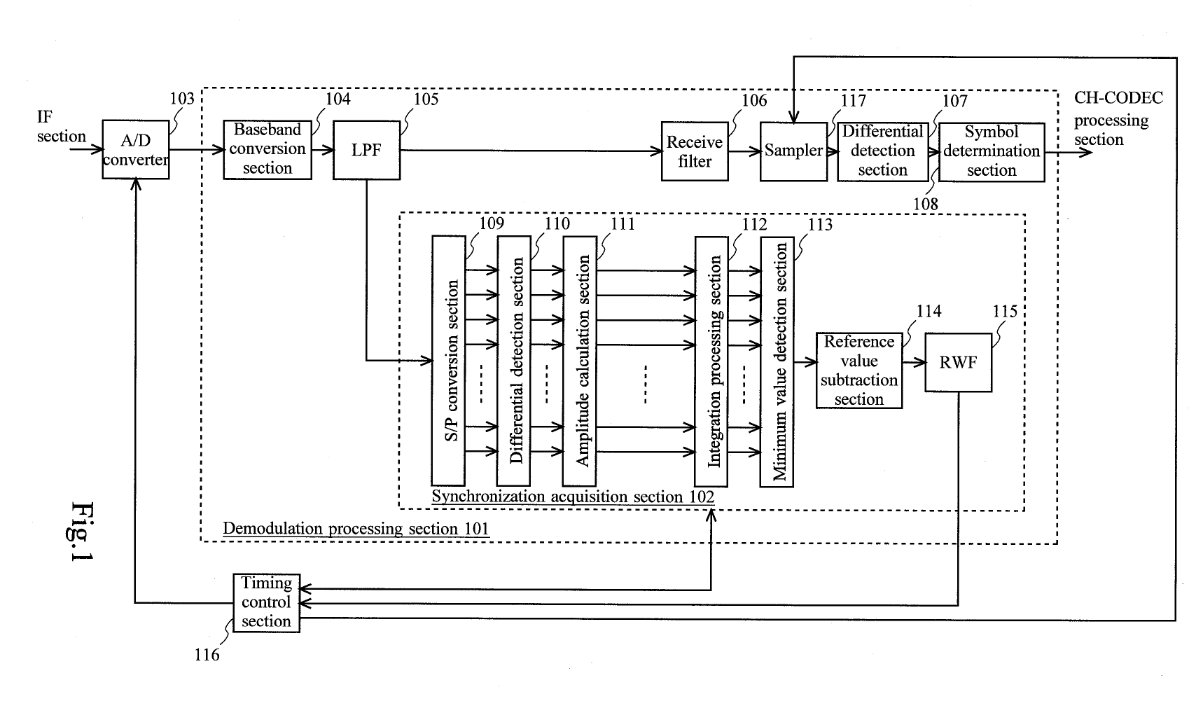

FIG. 1 is a schematic diagram of the wireless apparatus of a wireless communication system, according to this invention. With reference to FIG. 1, 101 is a demodulation processing section, 102 is a synchronization acquisition section, 103 is an A/D (Analog to Digital) converter, 104 is a baseband conversion section, 105 is an LPF (Low-Pass Filter), 106 is a receive filter, 107 is a differential detection section, 108 is a symbol determination section, 109 is an S/P (Serial/Parallel) conversion section, 110 is a differential detection section, 111 is an amplitude calculation section, 112 is an integration processing section, 113 is a minimum value detection section, 114 is a reference value subtraction section, 115 is an RWF (Random Walk Filter), 116 is a timing control section, and 117 is a sampler.

A signal received by an antenna (not shown) passes through an IF (Intermediate Frequency) section to the A/D converter 103, where the analog signal is converted to a digital signal. The sampling frequency is set to be N times the symbol frequency (where N is a positive integer). The received signal thus converted to a digital signal undergoes baseband conversion by the baseband conversion section 104 provided in the demodulation processing section 101, whereby it is demodulated into an in-phase I component and an quadrature Q component. Superfluous frequencies are then removed by the LPF 105. Data output from the LPF 105 is input to the receive filter 106 and to the synchronization acquisition section 102. The data input to the receive filter 106 is subjected to waveform shaping and the removal of noise components. Following this, the signal values of the symbol timing points are extracted by the sampler 117, and the data is then input to the differential detection section 107, where the conjugate complex of a signal with a delay of one symbol is multiplied by the present input signal to obtain a decode signal, and is then output via the symbol determination section 108 as decoded bit.

The oversampled portion of the serial signals (N signals, in this case) of the data input to the synchronization acquisition section 102 is converted to a parallel signal by the S/P conversion section 109. In the differential detection section 110, each of the N signals thus converted is multiplied by the conjugate complex of the delay data of one symbol stored in memory provided in the differential detection section 110, and input to the amplitude calculation section 111. At the amplitude calculation section 111, the amplitude value of the complex data detected by the differential detection section 110 is obtained and input to the integration processing section 112. The integration processing section 112 obtains the average of the input N amplitude values by performing partial integration of the N amplitude values.

Data output by the integration processing section 112 is input to the minimum value detection section 113, which finds which of the N data has the smallest value. The minimum value detection section 113 and the integration processing section 112 both have a buffer. The index value of the buffer where the minimum value is stored is found from the serial numbers (index values) in which the head of the buffer is 0.

At the reference value subtraction section 114, an intermediate buffer index value is set as a reference value, and the reference value is subtracted from the detected index value to calculate the difference between the index value of the buffer in which the minimum value is stored and the reference value. The difference from the reference value calculated by the reference value subtraction section 114 is input to the RWF 115, which absorbs errors in the difference from the reference value produced by noise included in the received signal, or by the effects of fading. The resulting difference from the reference value thus obtained is sent to the timing control section 116, where the timing is modified to reduce the difference, and the sampling signal is sent to the A/D converter 103. Based on the input from the RWF 115, the timing control section 116 controls the point of the symbol timing at which the signal value is extracted by the sampler 117.

Thus, by using detection of the minimum amplitude values of the baseband signal IQ components in the symbol timing detection, the invention makes it possible to stably acquire synchronization even when frequency deviation occurs. In accordance with the present invention, a wireless apparatus is provided that, even when frequency deviation occurs in the frequencies used for the wireless communication, enables symbol timing to be stably detected and timing synchronization to be achieved. Also, following the synchronization acquisition process, it can be verified that synchronization has been established. Synchronization can be verified by phase rotation by a predetermined degree, and frequency deviation calculated by the synchronization verification may also be used for frequency control.

This invention also provides a wireless apparatus for performing wireless communication, the wireless apparatus comprising: demodulation means for demodulating a signal; synchronization acquisition means for obtaining synchronization; and timing control means for adjusting signal timing; wherein the synchronization acquisition means calculates a difference from a reference value and performs clock phase correction.

This invention also provides a symbol timing detection method in a wireless apparatus for performing wireless communication, the wireless apparatus being provided with at least demodulation means for demodulating a signal, and synchronization acquisition means for obtaining synchronization, said detection method comprising a detection step of detecting a difference from a reference value, and a correction step of clock phase correction based on the difference from a reference value detected in the detection step.

A second embodiment of the invention will now be described.

This embodiment describes an example of a symbol synchronization system in received signal demodulation processing. The modulation system used is a π/4-shift QPSK system, with transmission of two bits per symbol.

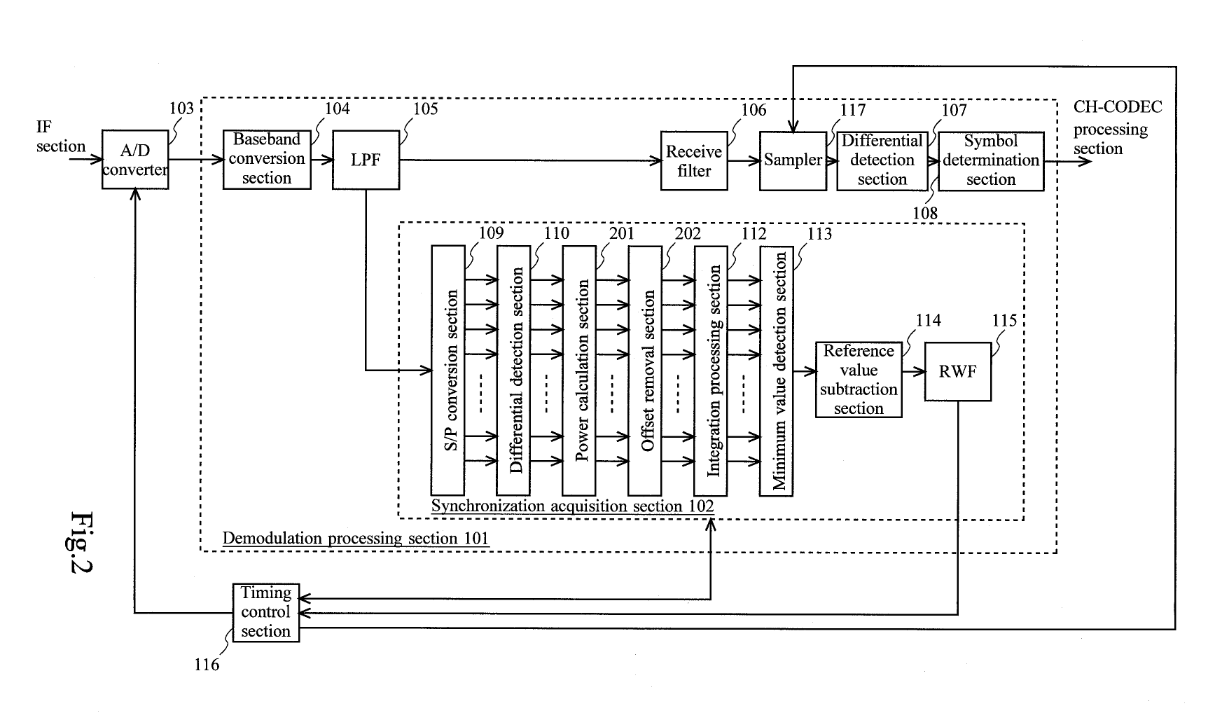

FIG. 2 shows the configuration of the demodulation section of the wireless apparatus. As shown, the demodulation section is provided with an A/D (Analog to Digital) converter 103, a demodulation processing section 101 and a timing control section 116. The demodulation processing section 101 has a synchronization acquisition section 102, an baseband conversion section 104, an LPF (Low-Pass Filter) 105, a receive filter 106, a sampler 117, a differential detection section 107 and a symbol determination section 108. The synchronization acquisition section 102 has an S/P (Serial/Parallel) conversion section 109, a differential detection section 110, an power calculation section 201, an offset removal section 202, an integration processing section 112, a minimum value detection section 113, a reference value subtraction section 114 and an RWF (Random Walk Filter) 115.

The operation of the demodulation section will now be described. A signal received by an antenna (not shown) passes via an IF (Intermediate Frequency) section to the A/D converter 103. In this case, the received signal has been modulated on the transmission side by π/4-shift QPSK modulation. In the A/D converter 103, the analog signal is converted to a digital signal and output to the baseband conversion section 104. The sampling frequency of the A/D converter 103 is set to be N times the symbol frequency (where N is a positive integer). In the baseband conversion section 104, this digital signal input from the A/D converter 103 undergoes baseband conversion, demodulating the signal into an in-phase I component and an quadrature Q component. The result of this conversion is output to the LPF 105, which removes frequencies superfluous to the I and Q component signals and outputs the result to the receive filter 106 and to the synchronization acquisition section 102. The I and Q component signals input to the receive filter 106 are subjected to waveform shaping and the removal of noise components, and the result is output to the sampler 117. The sampler 117 extracts the signal values (values of the I and Q components) of the symbol timing points, and outputs the data to the differential detection section 107. In the sampler 117, symbol periods are stored beforehand in memory, and symbol timing points are controlled by the timing control section 116.

Various configurations may be used for the sampler 117. For example, it can be configured to extract and output single sample values corresponding to the symbol timing from among N sample values of one symbol period, or it may be configured as an On-Off switch in which the output is switched on only at a timing that corresponds to the symbol timing.

With respect to the I and Q component signals input from the sampler 117, the differential detection section 107 multiplies the complex conjugate of a signal with a delay of one symbol stored in memory in the section 107 (that is, the signal of one symbol before) by the present input signal to obtain a decode signal that is output to the symbol determination section 108, where a determination of the decode signal is performed to acquire a decode bit that is then output to, for example, a channel codec (CH-CODEC) processing section.

The signal input to the synchronization acquisition section 102 from the LPF 105 is input to the S/P conversion section 109, where it is converted from a serial signal to N parallel signals that are output to the differential detection section 110. In this example, the N parallel signals correspond to N signals sampled by the A/D converter 103, forming the signal of one symbol period.

With respect to each of the I and Q component parallel signals input from the S/P conversion section 109, the differential detection section 110 multiplies the complex conjugate of a signal with a delay of one symbol stored in memory in the section 110 (that is, the signal of one symbol before) by the present input signal, and the multiplication result is output to the power calculation section 201.

Based on the values calculated by the differential detection section 110, the power calculation section 201 calculates the sum of squares (I²+Q²) of the I and Q components to obtain the complex data power (of N power data, in this example), which is output to the offset removal section 202. Generally, obtaining the square root of the power means the amplitude, so with respect to the power calculation section 201 and the amplitude calculation section 111 shown in FIG. 1, when the determination is of the size relationship, substantially the same values are obtained.

In this embodiment, π/4-shift QPSK modulation applied to the received signals by the differential detection section 110 is demodulated and the power of the demodulation result is obtained by the power calculation section 201. The demodulation result corresponds to a QPSK symbol point in the case of the symbol timing, and in other cases corresponds to either signal point on a line connecting adjacent QPSK symbol points. In the case of the preamble of a received signal portion in which the demodulated QPSK symbol point is the repeated alternation of “01” and “10”, for example, the power is at its highest at the symbol timings, and at its lowest at the midpoint between adjacent symbol timings. In data portions other than the preamble, also, where a “01” and “10”, or a “11” (+45 degrees) and “00” (−135 degrees) are adjacent, power is at the minimum at the midpoint thereof.

Based on the power values (N power values, in this example) of the parallel signals input from the power calculation section 201, the offset removal section 202 finds, as an offset value, the smallest of the power values, subtracts the offset value from the power value of each of the parallel signals to bring the minimum power value to zero, and outputs the parallel signal subtraction results to the integration processing section 112.

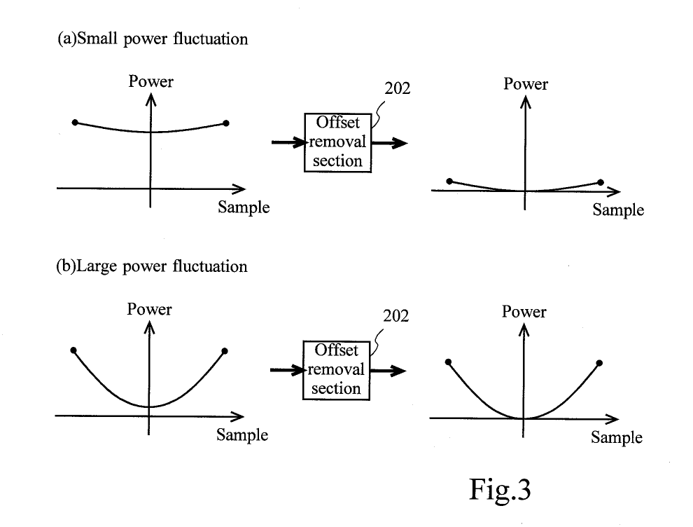

FIG. 3(a) shows an example of the power value of a parallel signal before and after offset removal, with respect to when there is a small power fluctuation, and FIG. 3(b) shows an example of the power value of a parallel signal before and after offset removal, with respect to when there is a large power fluctuation. In each graph, the left and right ends of the curve representing the power correspond to adjacent symbol points, and the midpoint of each curve corresponds to the midpoint between adjacent symbols. The curves each represent the period of one symbol.

As shown in FIG. 3(b), when the symbol point passes near the origin, the power fluctuation is large, facilitating the detection of the symbol timing. However, when, due to frequency deviation or noise or the like, the symbol point does not pass near the origin, such as in the case of FIG. 3(a), it is considered to be of low reliability as a signal used for symbol timing detection. Therefore, in this embodiment, the offset removal section 202 is used to remove the offset to bring the minimum power value to zero, thereby increasing the signal power fluctuation.

The integration processing section 112 performs integration processing on the power values (after offset removal) of each of the parallel signals input from the offset removal section 202, obtains the average value (the integration value, in this example) of each of these power values (each of N power values, in this example), and outputs the obtained average value to the minimum value detection section 113. Noise can be removed by this integration processing.

Here, the preferred integration mode is partial integration processing. With partial integration processing of a plurality of signal values in which, for example, 0<α<1, the result of the previous integration already obtained is multiplied by (1−α) and the result added to the result of multiplying the current signal value by α, and the result of the addition is used as the new integration result.

The minimum value detection section 113 stores the average power value of each of the parallel signals input from the integration processing section 112 (N average power values, in this example) in the respective buffer, finds the smallest value among the plurality of average power values, detects the index value of the buffer in which is stored the average power value corresponding to the minimum value, and communicates the detection result (index value) to the reference value subtraction section 114. In this example, the index value is a serial number in which the head of the buffer is 0, and index values 1 to N are allocated to the 1st to the Nth of N parallel signals.

Based on the index value information (index value of the buffer in which is stored the average power value corresponding to the minimum value) input from the minimum value detection section 113, the reference value subtraction section 114 calculates the difference between the index value of the buffer in which the minimum average power value is stored and a prescribed reference value, by subtracting the reference value from the index value and outputting the subtraction result to the RWF 115. In this example, an intermediate buffer index value is set as the reference value. Specifically, when the 0th to Nth index values are used, when N is an even number N/2 is used as the reference value, and when N is an odd number, (N+1)/2 or (N−1)/2 is used as the reference value.

The RWF 115 filters the values input from the reference value subtraction section 114, and outputs the result to the timing control section 116. This filtering absorbs errors in the difference from the reference value produced by noise included in the received signal, or by the effects of fading. Input values are sequentially added by being stored in a register. When the register value exceeds a prescribed positive threshold value (+L), a value (+1, for example) indicating that is output to the timing control section 116 and the register is cleared, zeroing the register value. If the register value goes below a prescribed negative threshold (−L), a value (−1, for example) indicating that is output to the timing control section 116 and the register is cleared, zeroing the register value.

Based on the input from the RWF 115, the timing control section 116 controls the point of symbol timing at which signal values are extracted by the sampler 117. The timing control section 116 also controls the numbering of reference values used by the reference value subtraction section 114 and buffer index values (index values used by the minimum value detection section 113) so that the numbers are staggered enough to stagger the points of symbol timing in the sampler 117.

As an example of this, when, on the basis of the input from the RWF 115, the difference obtained by subtracting a reference value from the index value of the buffer in which the minimum average power value is stored shows an increase in a positive direction (for example, when +1 is input from the RWF 115), the timing control section 116 delays the symbol timing in the sampler 117 by the amount of one sample, and also delays the reference value used by the reference value subtraction section 114 by the amount of one sample (to bring the index value of said buffer closer to the reference value). In the same way, when, on the basis of the input from the RWF 115, the difference obtained by subtracting a reference value from the index value of the buffer in which the minimum average power value is stored shows an increase in a negative direction (for example, when −1 is input from the RWF 115), the timing control section 116 speeds up the symbol timing in the sampler 117 by the amount of one sample, and also speeds up the reference value used by the reference value subtraction section 114 by the amount of one sample (to bring the index value of said buffer closer to the reference value). In this case, if at the initial values the timing of the reference value used by the reference value subtraction section 114 is made to coincide with the midpoint between adjacent symbol timings in the sampler 117, since the timings will also coincide thereafter, suitable symbol timing can be set in the sampler 117 by application of control that brings the index value of the buffer in which the minimum average power value is stored closer to the reference value (that is, so that the differences are reduced).

The timing control section 116 can also control the timing of sampling by the A/D converter 103, by outputting to the A/D converter 103 a signal that indicates the sampling timing. As an example of this, the timing control section 116 can carry out fine adjustment of the symbol timing by controlling the timing of the sampling by the A/D converter 103 to further reduce the minimum average power value detected by the minimum value detection section 113.

As described above, with the symbol timing detection method of this invention, in a receiver compatible with the π/4-shift QPSK modulation system, with respect to each of the sampling points of a generated received signal x (n) that is oversampled at a sampling frequency that is N times the symbol frequency (where N is a positive integer) and subjected to S/P conversion, the result v (n)=x(n)·x*(n−N) of the detection of the differential of the received signal x (n) is calculated, power |V(n)|² is calculated based on sum of (real part)² and (imaginary part)² of the differential detection result, offsets are removed to bring the minimum power value to zero, and after obtaining the average of past power signals (by integration, in this example), the smallest power value among N sampling points (which ideally is a zero crossing point at the midpoint of adjacent symbol timings) is detected and the timing is adjusted based on the difference between the sampling point at which the minimum power value was detected and the reference value, thereby establishing symbol synchronization.

This makes it possible to stably detect symbol timing and achieve symbol synchronization, even when frequency deviation occurs in the wireless communication frequencies that are used.

In this embodiment, for example, the values (of power, in this case) that are used which are calculated by the power calculation section 201 reflect both the I and Q components, so frequency deviation does not cause any change in power, making it possible to correctly detect the symbol timings. Also, the offset removal section 202 subtracts offset values from the power value of each of the parallel signals to bring the minimum power value to zero. Therefore, when there is a large power fluctuation, the value input to the integration processing section 112 can be increased, increasing the symbol timing detection effectiveness of the signal, and thereby raising the detection precision. Furthermore, the offset removal is carried out before the averaging.

While the synchronization acquisition section 102 has been described with reference to a configuration in which the midpoint between two adjacent symbol timing points is found by using the minimum value detection section 113 to find the smallest value among N average power values, other configurations may be used. For example, instead of the minimum value search section 113, a maximum value detection section may be used to detect symbol timing points by detecting the maximum among N average power values. If a maximum value detection section is used, based on the input from the RWF 115, the timing control section 116 is used to control the symbol timing points in the sampler 117, and to align the symbol timing points with the reference value used by the reference value subtraction section 114 to bring the index value of the buffer in which the maximum average power value is stored, closer to the reference value. As an example, the timing control section 116 can carry out fine adjustment of the symbol timing by controlling the timing of the sampling by the A/D converter 103 to further increase the maximum average power value (of N average power values, in this example) detected by the maximum value detection section.

The demodulation section of the wireless apparatus comprises sampling means constituted by the sampling function of the A/D converter 103; extraction means constituted by the function of the sampler 117 of extracting signal values taken to be at symbol timing points; and demodulation means constituted by the function of the differential detection section 107 of demodulating (differential detection, in this embodiment) the extracted signal values. Sampling point demodulation means is constituted by the function of the differential detection section 110 of demodulating (differential detection, in this embodiment) of the signal values of each sampling point; value detection means is constituted by the function of the power calculation section 201 (or of the amplitude calculation section 111 shown in FIG. 1) of detecting the power value (or amplitude value) at each sampling point. The offset removal means is constituted by the function of the offset removal section 202 of removing the offsets of the power values (or amplitude values); the averaging means is constituted by the function of the integration processing section 112 of performing integration processing (an example of averaging) with respect to power values (or amplitude values) after offset removal; the symbol timing detection means is constituted by the function of the timing control section 116 of symbol timing detection based on the results of the processing by the minimum value detection section 113, reference value subtraction section 114 or RWF 115; the symbol timing control means is constituted by the function of the timing control section 116 of controlling the symbol timing in the sampler 117 based on the symbol timing detection results; and the sampling control means is constituted by the function of the timing control section 116 of controlling the timing of the sampling by the A/D converter 103.

The configuration of the system and apparatus according to the present invention is not limited to that set out in the foregoing, various other configurations also being possible. This invention may be provided as a program for effecting the methods of executing the processing of this invention, or as said program recorded on a recording medium. In addition, the field of application of the invention is not necessarily limited to that described in the foregoing, application of the invention to various other fields also being possible.

Moreover, the various processes performed in the system or apparatus of the invention may be implemented in hardware resources equipped with a processor and memory and the like, controlled by means of a processor executing a control program stored in ROM (Read Only Memory), for example. The various functional means for executing this processing may also be constituted as independent hardware circuits.

In addition, the present invention may also be understood as one wherein the above control program is stored on a Floppy disc, CD (Compact Disc)-ROM or other computer-readable recording medium, so that the processing according to the present invention can be implemented by said control program being input from the recording media into a computer and executed by a processor.

What is claimed is:

1. A symbol timing detector that detects symbol timing of a modulated signal, the detector comprising:
sampling means for sampling a signal value of the modulated signal at a period that is shorter than a symbol period;
sampling point demodulation means that carries out demodulation in respect of signal values at sampling points sampled by the sampling means;
value detection means that detects power values or amplitude values resulting from demodulation at sampling points obtained by the sampling point demodulation means; and
symbol timing detection means that detects a timing taken to be symbol timing based on values at sampling points detected by the value detection means.

2. A symbol timing detector according to claim 1, further comprising:
offset removal means that performs a shift whereby, with respect to the values at a plurality of sampling points detected by the value detection means, the minimum value of one symbol period becomes zero or close to zero; and
averaging means that averages values at each sampling point shifted by the offset removal means;
wherein based on the result of the averaging by the averaging means, the symbol timing detection means detects a timing that is taken to be the symbol timing.

3. A symbol timing detector according to claim 1, wherein the symbol timing detection means detects symbol timing based on the amplitude of the values at each sampling point, using a signal portion in which the values are largest at symbol timings and smallest at the midpoint between adjacent symbol timings.

4. A symbol timing detector according to claim 2, wherein the symbol timing detection means detects symbol timing based on the amplitude of the values at each sampling point, using a signal portion in which the values are largest at symbol timings and smallest at the midpoint between adjacent symbol timings.

5. A symbol timing detector according to claim 1 that uses a π/4-shift QPSK digital modulation system.

6. A symbol timing detector according to claim 2 that uses a π/4-shift QPSK digital modulation system.

7. A wireless terminal that detects symbol timing of received modulated signals and demodulates the signals, the terminal comprising:
sampling means that samples signal values of the modulated signals at a period that is shorter than a symbol period;
extraction means that extracts from among signal values at a plurality of sampling points sampled by the sampling means, signal values that are taken to be at symbol timing points;
demodulation means that performs demodulation in respect of the extracted signal values;
sampling point demodulation means that performs demodulation in respect of signal values at each of the sampling points sampled by the sampling means;
value detection means that detects power or amplitude values resulting from demodulation at the sampling points obtained by the sampling point demodulation means; and
symbol timing control means that controls the timing of what is taken to be symbol timing by the extraction means, based on the power or amplitude values at each of the sampling points detected by the value detection means.

8. A wireless terminal according to claim 7, further comprising:
offset removal means that performs a shift whereby, with respect to the power or amplitude values at a plurality of sampling points detected by the value detection means, the minimum value of one symbol period becomes zero or close to zero; and
averaging means that averages values at each sampling point shifted by the offset removal means;
wherein the symbol timing control means controls the timing of what is taken to be symbol timing by the extraction means, based on the results of the averaging by the averaging means.

9. A wireless terminal according to claim 7 that is equipped with sampling control means that controls the timing of sampling by the sampling means.

10. A wireless terminal according to claim 8 that is equipped with sampling control means that controls the timing of sampling by the sampling means.

11. A wireless terminal according to claim 9, wherein the sampling control means controls the timing of sampling by the sampling means to decrease the minimum value of one symbol period of values detected by the value detection means, or to increase the maximum value of one symbol period of values detected by the value detection means.

12. A wireless terminal according to claim 10, wherein the sampling control means controls the timing of sampling by the sampling means to decrease the minimum value of one symbol period of averaged results by the averaging means, or to increase the maximum value of one symbol period of averaged results by the averaging means.

13. A wireless terminal according to claim 7 that uses a π/4-shift QPSK digital modulation system.

14. A wireless terminal according to claim 8 that uses a π/4-shift QPSK digital modulation system.

15. A received signal processing method that detects the symbol timing of a received modulated signal and demodulates the modulated signal, the method comprising the steps of
sampling signal values of the modulated signal at a period that is shorter than the symbol period;
extracting from among sampled signal values at a plurality of sampling points, signal values that are taken to be at symbol timing points;
demodulating extracted signal values;
modulating sampled signal values at each of the sampling points;
detecting power or amplitude values resulting from the demodulation at each of the sampling points obtained by the demodulation; and
controlling the timing taken to be symbol timing in the extraction based on the detected values at each of the sampling points.

16. A received signal processing method according to claim 15 that includes the steps of
effecting a shift whereby, with respect to the detected values at the plurality of sampling points, the minimum value of one symbol period becomes zero or close to zero; and
averaging the shifted values at each sampling point;
wherein the timing of what is taken to be symbol timing in the extraction based on averaged results obtained by the averaging is controlled by the symbol timing control step.

17. A received signal processing method according to claim 15 that includes the further step of controlling the timing of the sampling.

18. A received signal processing method according to claim 16 that includes the further step of controlling the timing of the sampling.
